(19) United States
(12) Patent Application Publication
(10) Pub. No.: US 2026/0331044 A1
(43) Pub. Date: Oct. 22, 2026

(54) PIXEL CIRCUIT, DRIVING METHOD AND DISPLAY DEVICE

(71) Applicants: Chongqing BOE Display Technology Co., Ltd., Chongqing (CN); BOE TECHNOLOGY GROUP CO., LTD., Beijing (CN)

(72) Inventors: Rui Wang, Beijing (CN); Yaoyao Hu, Beijing (CN); Shuangyuan Zhan, Beijing (CN); Xiaoling He, Beijing (CN); Weidi Xia, Beijing (CN)

(73) Assignees: Chongqing BOE Display Technology Co., Ltd., Chongqing (CN); BOE TECHNOLOGY GROUP CO., LTD., Beijing (CN)

(21) Appl. No.: 18/992,270

(22) PCT Filed: Dec. 21, 2023
(86) PCT No.: PCT/CN2023/140562

§ 371 Date: Jan. 8, 2025

(51) Int. Cl. G09G 3/3233

(52) U.S. Cl. CPC G09G 3/3233; G09G 2300/043; G09G 2300/0819; G09G 2300/0842; G09G 2320/045

(57) ABSTRACT

A pixel circuit, a driving method and a display device are provided. The pixel circuit includes N sub-pixels, N first initial voltage terminals and N second initial voltage terminals, wherein n is a positive integer less than or equal to N; an n^{th} sub-pixel includes an n^{th} driving circuit, an n^{th} light emitting element, an n^{th} one of first initialization circuits, an n^{th} one of second initialization circuits and an n^{th} one of first light emitting control circuits; the n^{th} one of the first initialization circuits is configured to write an n^{th} one of first initial voltages into an n^{th} one of third nodes under the control of a first reset control signal; the n^{th} one of the second initialization circuits is configured to write an n^{th} one of second initial voltages into an n^{th} one of second nodes under the control of a second reset control signal.

### TECHNICAL FIELD

The present disclosure relates to the field of display technology, in particular to a pixel circuit, a driving method and a display device.

### BACKGROUND

In the related art, a red sub-pixel, a green sub-pixel and a blue sub-pixel are reset by using a same initial voltage. For a first node (the first node is a node electrically connected to the control terminal of the driving circuit), since a pixel current of the blue sub-pixel is relatively large, a data voltage corresponding to the blue sub-pixel is different from a data voltage of other color sub-pixels. Therefore, resetting the first node with the same initial voltage may cause a display deviation due to different charge rates. For a third node (the third node is a node electrically connected to the second terminal of the driving circuit), the pixel current of the blue sub-pixel is greater than the pixel current of the red sub-pixel, the pixel current of the blue pixel is greater than the pixel current of the green sub-pixel, hysteresis of a driving transistor in the blue sub-pixel is greater than the hysteresis of the driving transistor in the red sub-pixel, and the hysteresis of the driving transistor in the blue sub-pixel is greater than the hysteresis of the driving transistor in the blue sub-pixel. Therefore, resetting a second node with the same initial voltage may easily cause the display deviation.

### SUMMARY

In a first aspect, the present disclosure provides a pixel circuit, including: N sub-pixels, N first initial voltage terminals and N second initial voltage terminals, wherein N is an integer greater than 1 and n is a positive integer less than or equal to N;
an n^{th} sub-pixel includes an n^{th} driving circuit, an n^{th} light emitting element, an n^{th} one of first initialization circuits, an n^{th} one of second initialization circuits and an n^{th} one of first light emitting control circuits;
a control terminal of the n^{th} driving circuit is electrically connected to an n^{th} one of first node, a first terminal of the n^{th} driving circuit is electrically connected to an n^{th} one of second nodes, a second terminal of the n^{th} driving circuit is electrically connected to an n^{th} one of third nodes, and the n^{th} driving circuit is configured to generate a driving current for driving the n^{th} light emitting element under the control of a potential of the n^{th} first node;
the n^{th} one of the first light emitting control circuits is electrically connected to each of a light emitting control terminal, the n^{th} one of the third nodes and a first electrode of the n^{th} light emitting element, and is configured to control the n^{th} one of the third nodes to be electrically connected to the first electrode of the n^{th} light emitting element under the control of a light emitting control signal provided by the light emitting control terminal, and a second electrode of the n^{th} light emitting element is electrically connected to a second voltage terminal;
the n^{th} one of the first initialization circuit is electrically connected to each of a first reset control terminal, an n^{th} one of the first initial voltage terminals and the n^{th} one of the third nodes, and is configured to write an n^{th} one of first initial voltages provided by the n^{th} one of the first initial voltage terminals into the n^{th} one of the third nodes under the control of a first reset control signal provided by the first reset control terminal;
the n^{th} one of the second initialization circuits is electrically connected to each of a second reset control terminal, an n^{th} one of the second initial voltage terminals and the n^{th} one of the second nodes, and is configured to write an n^{th} one of second initial voltages provided by the n^{th} one of the second initial voltage terminals into the n^{th} one of the second nodes under the control of a second reset control signal provided by the second reset control terminal;
first initial voltages provided by at least two of the first initial voltage terminals are different from each other, and/or the second initial voltages provided by at least two of the second initial voltage terminals are different from each other.

Optionally, the pixel circuit includes three sub-pixels, a first one of the sub-pixels is a red sub-pixel, a second one of the sub-pixels is a green sub-pixel, and a third one of the sub-pixels is a blue sub-pixel;
a first one of the first initial voltages is different from a third one of the first initial voltages, and a second one of the first initial voltages is different from the third one of the first initial voltages.

Optionally, a driving transistor included in each driving circuit is a p-type transistor, the first one of the first initial voltages is greater than the third one of the first initial voltages, and the second one of the first initial voltages is greater than the third one of the first initial voltages; or
a driving transistor included in each driving circuit is an n-type transistor, the first one of the first initial voltages is less than the third one of the first initial voltages, and the second one of the first initial voltages is less than the third one of the first initial voltages.

Optionally, the first one of the first initial voltages is equal to the second one of the first initial voltages.

Optionally, the driving transistor is a p-type transistor, and the first one of the first initial voltages is less than the second one of the first initial voltages; or
the driving transistor is the p-type transistor, and the first one of the first initial voltages is greater than the second one of the first initial voltages.

Optionally, the pixel circuit includes three sub-pixels, a first one of the sub-pixels is a red sub-pixel, a second one of the sub-pixels is a green sub-pixel, and a third one of the sub-pixels is a blue sub-pixel;
a first one of the second initial voltages is different from a third one of the second initial voltages, and a second one of the second initial voltages is different from the third one of the second initial voltages.

Optionally, a driving transistor included in each driving circuit is a p-type transistor, the first one of the second initial voltages is greater than the third one of the second initial voltages, and the second one of the second initial voltages is greater than the third one of the second initial voltages; or
a driving transistor included in each driving circuit is an n-type transistor, the first one of the second initial voltages is less than the third one of the second initial voltages, and the second one of the second initial voltages is less than the third one of the second initial voltages.

Optionally, the first one of the second initial voltages is equal to the second one of the second initial voltages.

Optionally, the driving transistor is the p-type transistor, and the first one of the second initial voltages is less than the second one of the second initial voltages; or
the driving transistor is the n-type transistor, and the first one of the second initial voltages is greater than the second one of the second initial voltages.

Optionally, the pixel circuit further includes N third initial voltage terminals, and the n^{th} sub-pixel further includes an n^{th} one of third initialization circuits;
the n^{th} one of the third initialization circuits is electrically connected to each of a third reset control terminal, an n^{th} one of the third initial voltage terminals and the first electrode of the n^{th} light emitting element, and is configured to write an n^{th} one of third initial voltages provided by the n^{th} one of the third initial voltage terminals into the first electrode of the n^{th} light emitting element under the control of a third reset control signal provided by the third reset control terminal.

Optionally, the third initial voltages provided by the N third initial voltage terminals are the same.

Optionally, the n^{th} sub-pixel further includes an n^{th} energy storage circuit, an n^{th} compensation control circuit and an n^{th} data writing circuit;
a first terminal of the n^{th} energy storage circuit is electrically connected to the n^{th} one of the first nodes, a second terminal of the n^{th} energy storage circuit is electrically connected to a direct current voltage terminal, and the n^{th} energy storage circuit is configured to store electrical energy;
the n^{th} compensation control circuit is electrically connected to each of a compensation control terminal, the n^{th} one of the first nodes and the n^{th} one of the third nodes, and is configured to control the n^{th} one of the first nodes to be electrically connected to the n^{th} one of the third nodes under the control of a compensation control signal provided by the compensation control terminal; and
the n^{th} data writing circuit is electrically connected to each of a writing control terminal, an n^{th} data line and the n^{th} one of the second nodes, and is configured to write an n^{th} data voltage provided by the n^{th} data line into the n^{th} one of the second nodes under the control of a writing control signal provided by the writing control terminal.

Optionally, the n^{th} sub-pixel further includes an n^{th} one of second light emitting control circuits;
the n^{th} one of the second light emitting control circuits is electrically connected to each of the light emitting control terminal, a first voltage terminal and the n^{th} one of the second nodes, and is configured to control the first voltage terminal to be electrically connected to the n^{th} one of the second nodes under the control of the light emitting control signal.

In a second aspect, the present disclosure provides a driving method, applied to the pixel circuit, wherein the driving method includes:
generating, by the n^{th} driving circuit, the driving current for driving the n^{th} light emitting element under the control of a potential of the n^{th} one of the first nodes;
controlling, by the n^{th} one of the first light emitting control circuits, the n^{th} one of the third nodes to be electrically connected to the first electrode of the n^{th} light emitting element under the control of the light emitting control signal;
writing, by the n^{th} one of the first initialization circuits, the n^{th} one of the first initial voltages provided by the n^{th} one of the first initial voltage terminals into the n^{th} one of the third nodes under the control of the first reset control signal;
writing, by the n^{th} one of the second initialization circuits, the n^{th} one of second initial voltages provided by the n^{th} one of the second initial voltage terminals into the n^{th} one of the second nodes under the control of the second reset control signal;
the first initial voltages provided by at least two of the first initial voltage terminals are different from each other, and/or the second initial voltages provided by at least two of the second initial voltage terminals are different from each other;
wherein N is an integer greater than 1 and n is a positive integer less than or equal to N.

In a third aspect, the present disclosure provides a display device including the pixel circuit.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a circuit diagram of a pixel circuit according to at least one embodiment of the present disclosure;

FIG. 4 is a circuit diagram of a pixel circuit according to at least one embodiment of the present disclosure;

FIG. 5 is a circuit diagram of a pixel circuit according to at least one embodiment of the present disclosure;

FIG. 6 is a circuit diagram of a pixel circuit according to at least one embodiment of the present disclosure;

FIG. 7 is a circuit diagram of a pixel circuit according to at least one embodiment of the present disclosure.

### DETAILED DESCRIPTION

The technical solutions in the embodiments of the present disclosure will be clearly and thoroughly described hereinafter in conjunction with the accompanying drawings in the embodiments of the present disclosure. Obviously, the described embodiments are only a part of the embodiments of the present disclosure, not all of them. Based on the embodiments in the present disclosure, all other embodiments obtained by those of ordinary skill in the art without creative efforts shall fall within the protection scope of the present disclosure.

The transistors used in all the embodiments of the present disclosure may be a thin film transistor, a field effect transistor or other devices with a same characteristics. In the embodiments of the present disclosure, in order to distinguish two electrodes of a transistor other than a gate electrode, one of the electrodes is referred to as a first electrode, and the other electrode is referred to as a second electrode.

In practical operation, when the transistor is the thin film transistor or the field effect transistor, the first electrode may be a drain electrode, and the second electrode may be a source electrode, or the first electrode may be a source electrode, and the second electrode may be a drain electrode.

The pixel circuit according to the embodiments of the present disclosure includes N sub-pixels, N first initial voltage terminals and N second initial voltage terminals, wherein N is an integer greater than 1 and n is a positive integer less than or equal to N;
an n^{th} sub-pixel includes an n^{th} driving circuit, an n^{th} light emitting element, an n^{th} one of first initialization circuits, an n^{th} one of second initialization circuits and an n^{th} one of first light emitting control circuits;
a control terminal of the n^{th} driving circuit is electrically connected to an n^{th} one of first nodes, a first terminal of the n^{th} driving circuit is electrically connected to an n^{th} one of second nodes, a second terminal of the n^{th} driving circuit is electrically connected to an n^{th} one of third nodes, and the n^{th} driving circuit is configured to generate a driving current for driving the n^{th} light emitting element under the control of a potential of the n^{th} one of the first nodes;
the n^{th} one of the first light emitting control circuits is electrically connected to each of a light emitting control terminal, the n^{th} one of the third nodes and a first electrode of the n^{th} light emitting element, and is configured to control the n^{th} one of the third nodes to be electrically connected to the first electrode of the n^{th} light emitting element under the control of a light emitting control signal provided by the light emitting control terminal to perform light-emitting control, and a second electrode of the n^{th} light emitting element is electrically connected to a second voltage terminal;
the n^{th} one of the first initialization circuits is electrically connected to each of a first reset control terminal, an n^{th} one of first initial voltage terminals and the n^{th} one of the third nodes, and is configured to write an n^{th} one of first initial voltages provided by the first initial voltage terminal into the n^{th} one of the third nodes under the control of a first reset control signal provided by the first reset control terminal to initialize a potential of the n^{th} one of the third nodes;
the n^{th} one of the second initialization circuits is electrically connected to each of a second reset control terminal, an n^{th} one of the second initial voltage terminals and the n^{th} one of the second nodes, and is configured to write an n^{th} one of second initial voltages provided by the n^{th} one of the second initial voltage terminals into the n^{th} one of the second nodes under the control of a second reset control signal provided by the second reset control terminal to initialize a potential of the n^{th} one of the second nodes;
the first initial voltages provided by at least two of the first initial voltage terminals are different from each other, and/or the second initial voltages provided by at least two of the second initial voltage terminals are different from each other.

In the related art, a red sub-pixel, a green sub-pixel and a blue sub-pixel are reset by using a same initial voltage. For a first node (the first node is a node electrically connected to the control terminal of the driving circuit), since a pixel current of the blue sub-pixel is relatively large, when a driving transistor included in the n^{th} driving circuit is a p-type transistor, the required data voltage is more negative, the initial voltage corresponding to the blue sub-pixel should be lower, and when the driving transistor included in the n^{th} driving circuit is an n-type transistor, the required data voltage is more positive, and the initial voltage corresponding to the blue sub-pixel should be higher, so that a charging rate is improved. For a second node (the second node is a node electrically connected to the first terminal of the driving circuit), the pixel current of the blue sub-pixel is greater than the pixel current of the red sub-pixel, the pixel current of the blue pixel is greater than the pixel current of the green sub-pixel, the hysteresis of the driving transistor in the blue sub-pixel is greater than the hysteresis of the driving transistor in the red sub-pixel, and the hysteresis of the driving transistor in the blue sub-pixel is greater than the hysteresis of the driving transistor in the blue sub-pixel. Therefore, resetting the second node with the same initial voltage may easily cause a display deviation.

In at least one embodiment of the present disclosure, first initial voltages provided by at least two of the first initial voltage terminals are different from each other, and/or second initial voltages provided by at least two of the second initial voltage terminals are different from each other. The first node in the sub-pixel of each color can be reset by a respective one of different initial voltages, the second node in the sub-pixel of each color can be reset by a respective one of different initial voltages. The coordinated adjustment of multiple initial voltages enables image display with higher precision at a high frequency.

When the driving transistor is a p-type transistor, the data voltage corresponding to the blue sub-pixel is the smallest. Thus, when the respective first initial voltages corresponding to the red sub-pixel, the green sub-pixel and the blue sub-pixel are the same, a voltage difference between the data voltage and the first initial voltage for the blue sub-pixel may be small, resulting in a lower charging rate. Therefore, in at least one embodiment of the present disclosure, when the driving transistor is a p-type transistor, a third one of the first initial voltages is set to be smaller, so that the respective charging rates corresponding to the red sub-pixel, the green sub-pixel, and the blue sub-pixel are approximately the same.

When the driving transistor is an n-type transistor, the data voltage corresponding to the blue sub-pixel is the largest. Thus, when the respective first initial voltages corresponding to the red sub-pixel, the green sub-pixel and the blue sub-pixel are the same, the voltage difference between the data voltage and the first initial voltage for the blue sub-pixel would be large, resulting in a higher charging rate. Therefore, in at least one embodiment of the present disclosure, when the driving transistor is a p-type transistor, the third one of the first initial voltage is set to be greater, so that the respective charging rates corresponding to the red sub-pixel, the green sub-pixel, and the blue sub-pixel are approximately the same.

In at least one embodiment of the present disclosure, when the driving transistor is a p-type transistor, a voltage value of each first initial voltage may be greater than or equal to −5V and less than or equal to −3V, and a voltage value of each second initial voltage may be greater than or equal to 5V and less than or equal to 8V, but the present disclosure is not limited thereto. In a specific implementation, each first initial voltage and each second initial voltage may be selected according to an actual condition.

An example in which N is equal to 3 is taken as an example for description below.

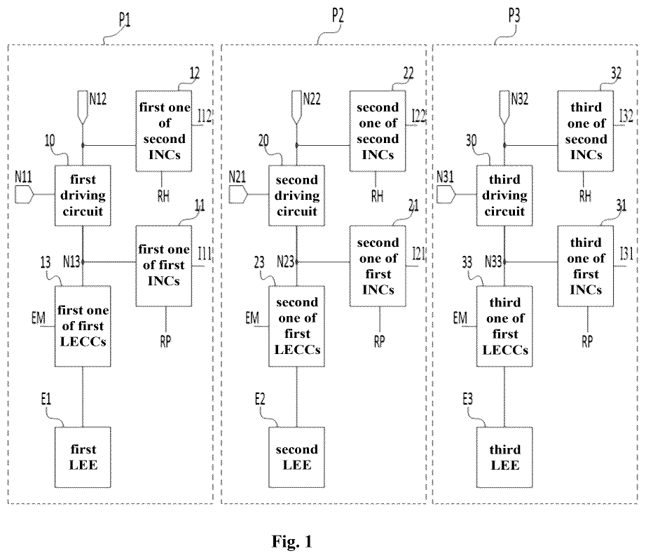

As shown in FIG. 1, the pixel circuit according to the embodiment of the present disclosure includes a first sub-pixel P1, a second sub-pixel P2, a third sub-pixel P3, a first one of first initial voltage terminals I11, a second one of first initial voltage terminals I21, a third one of first initial voltage terminals I31, a first one of second initial voltage terminals I12, a second one of second initial voltage terminals I22, and a third one of second initial voltage terminals I32.

The first sub-pixel P1 includes a first driving circuit 10, a first light emitting element (LEE) E1, a first one of first initialization circuits (INC) 11, a first one of second initialization circuits 12, and a first one of first light emitting control circuits (LECCs) 13.

A control terminal of the first driving circuit 10 is electrically connected to a first one of first nodes N11, a first terminal of the first driving circuit 10 is electrically connected to a first one of second nodes N12, a second terminal of the first driving circuit 10 is electrically connected to a first one of third nodes N13, and the first driving circuit is configured to generate a driving current for driving the first light emitting element E1 under the control of a potential of the first one of the first nodes N11.

The first one of the first light emitting control circuits 13 is electrically connected to each of a light emitting control terminal EM, the first one of the third nodes N13 and a first electrode of the first light emitting element E1, and is configured to control the first one of the third nodes N13 to be electrically connected to the first electrode of the first light emitting element E1 under the control of a light emitting control signal provided by the light emitting control terminal EM, and a second electrode of the first light emitting element E1 is electrically connected to a second voltage terminal V2.

The first one of the first initialization circuits 11 is electrically connected to each of a first reset control terminal RP, the first one of the first initial voltage terminals I11 and the first one of the third nodes N13, and is configured to write a first one of first initial voltages provided by the first one of the first initial voltage terminals I11 into the first one of the third nodes N13 under the control of a first reset control signal provided by the first reset control terminal RP1.

The first one of the second initialization circuits 12 is electrically connected to each of a second reset control terminal RH, the first one of the second initial voltage terminals I12 and the first one of the second nodes N12, and is configured to write a first one of second initial voltages provided by the first one of the second initial voltage terminals I12 into the first one of the second nodes N12 under the control of a second reset control signal provided by the second reset control terminal RH.

The second sub-pixel P2 includes a second driving circuit 20, a second light emitting element E2, a second one of the first initialization circuits 21, a second one of the second initialization circuits 22, and a second one of the first light emitting control circuits 23.

A control terminal of the second driving circuit 20 is electrically connected to a second one of the first nodes N21, a first terminal of the second driving circuit 20 is electrically connected to a second one of the second nodes N22, a second terminal of the second driving circuit 20 is electrically connected to a second one of the third nodes N23, and the second driving circuit 20 is configured to generate a driving current for driving the second light emitting element E2 under the control of a potential of the second one of the first nodes N21.

The second one of the first light emitting control circuit 23 is electrically connected to each of the light emitting control terminal EM, the second one of the third nodes N23 and a first electrode of the second light emitting element E2, and is configured to control the second one of the third nodes N23 to be electrically connected to the first electrode of the second light emitting element E2 under the control of the light emitting control signal provided by the light emitting control terminal EM, and a second electrode of the second light emitting element E2 is electrically connected to the second voltage terminal V2.

The second one of the first initialization circuits 21 is electrically connected to each of a first reset control terminal RP, the second one of the first initial voltage terminals I21 and the second one of the third nodes N23, and is configured to write a second one of the first initial voltages provided by the second one of the first initial voltage terminals I21 into the second one of the third nodes N23 under the control of the first reset control signal provided by the first reset control terminal RP.

The second one of the second initialization circuits 22 is electrically connected to each of a second reset control terminal RH, the second one of the second initial voltage terminal I22 and the second one of the second nodes N22, and is configured to write the second one of the second initial voltages provided by the second one of the second initial voltage terminals I22 into the second one of the second nodes N22 under the control of the second reset control signal provided by the second reset control terminal RH.

The third sub-pixel P3 includes a third driving circuit 30, a third light emitting element E3, a third one of the first initialization circuits 31, a third one of the second initialization circuits 32, and a third one of the first light emitting control circuit 33.

A control terminal of the third driving circuit 30 is electrically connected to a third one of the first nodes N31, a first terminal of the third driving circuit 30 is electrically connected to a third one of the second nodes N32, a second terminal of the third driving circuit 20 is electrically connected to a third one of the third nodes N33, and the third driving circuit 20 is configured to generate a driving current for driving the third light emitting element E3 under the control of a potential of the third one of the first nodes N31.

The third one of the first light emitting control circuits 33 is electrically connected to each of a light emitting control terminal EM, the third one of the third nodes N33 and a first electrode of the third light emitting element E3, and is configured to control the third one of the third nodes N33 to be electrically connected to the first electrode of the third light emitting element E3 under the control of a light emitting control signal provided by the light emitting control terminal EM, and a second electrode of the third light emitting element E3 is electrically connected to the second voltage terminal V2.

The third one of the first initialization circuits 31 is electrically connected to each of a first reset control terminal RP, a third one of first initial voltage terminals I31 and the third one of the third nodes N33, and is configured to write a third one of first initial voltages provided by the third one of the first initial voltage terminals I31 into the third one of the third nodes N33 under the control of the first reset control signal provided by the first reset control terminal RP.

The third one of the second initialization circuit 32 is electrically connected to each of a second reset control terminal RH, a third one of second initial voltage terminals I32 and the third one of the second nodes N32, and is configured to write a second one of second initial voltages provided by the second one of the second initial voltage terminals I22 into the third one of the second nodes N32 under the control of the second reset control signal provided by the second reset control terminal RH.

Optionally, the pixel circuit includes three sub-pixels, a first one of the sub-pixels is a red sub-pixel, a second one of the sub-pixels is a green sub-pixel, and a third one of the sub-pixels is a blue sub-pixel.

A first one of first initial voltages is different from a third one of first initial voltages, and a second one of the first initial voltages is different from the third one of the first initial voltages.

In at least one embodiment of the present disclosure, the first one of the first initial voltages is the first initial voltage provided to the first sub-pixel, the second one of the first initial voltages is the first initial voltage provided to the second sub-pixel, and the third one of the first initial voltages is the first initial voltage provided to the third sub-pixel.

In a specific implementation, since the pixel current of the blue sub-pixel is relatively large, the required data voltage is more negative. Therefore, the third one of the first initial voltages corresponding to the blue sub-pixel is set to be different from the first initial voltage corresponding to the other two sub-pixels, so as to avoid a display deviation caused by using a same first initial voltage.

In at least one embodiment of the present disclosure, when the driving transistor included in each driving circuit is a p-type transistor, the first one of the first initial voltages is greater than the third one of the first initial voltages, and the second one of the first initial voltages is greater than a third one of first initial voltages.

When each driving transistor is an n-type transistor, the first one of the first initial voltages is less than the third one of the first initial voltages, and the second one of first initial voltages is less than the third one of the first initial voltages.

In a specific implementation, when the driving transistor is a p-type transistor, a voltage value of the third one of the first initial voltages may be set to be smaller.

When the driving transistor is an n-type transistor, the voltage value of the third one of the first initial voltages may be set to be larger.

Optionally, the first one of the first initial voltages is equal to the second one of the first initial voltages.

In a specific implementation, the first one of the first initial voltages can be equal to the second one of the first initial voltages.

In at least one embodiment of the present disclosure, when the driving transistor is a p-type transistor, the first one of the first initial voltages is less than the second one of the first initial voltages; and when the driving transistor is an n-type transistor, the first one of the first initial voltages is greater than the second one of the first initial voltages.

In a specific implementation, since the pixel current of the red sub-pixel is greater than the pixel current of the green sub-pixel, when the driving transistor is a p-type transistor, the first one of the first initial voltages may be set to be less than the second one of the first initial voltages, so that the charging rate of the red sub-pixel and the charging rate of the green sub-pixel are approximately the same. When the driving transistor is an n-type transistor, the first one of the first initial voltages may be set to be greater than the second one of the first initial voltage, so that the charging rate of the red sub-pixel and the charging rate of the green sub-pixel are approximately the same.

In at least one embodiment of the present disclosure, the pixel circuit includes three sub-pixels, a first one of the sub-pixels is a red sub-pixel, a second one of the sub-pixels is a green sub-pixel, and a third one of the sub-pixels is a blue sub-pixel.

A first one of second initial voltages is different from a third one of second initial voltages, and a second one of second initial voltages is different from the third one of the second initial voltages.

In a specific implementation, since the pixel current of the blue sub-pixel is relatively large, the required data voltage is more negative.

Therefore, the third one of the second initial voltages corresponding to the blue sub-pixel is set to be different from the second initial voltage corresponding to the other two sub-pixels, so as to avoid a display deviation caused by using a same second initial voltage.

Optionally, when the driving transistor included in each driving circuit is a p-type transistor, the first one of the second initial voltages is greater than the third one of the second initial voltages, and the second one of the second initial voltages is greater than a third one of second initial voltages.

When each driving transistor is an n-type transistor, the first one of the second initial voltages is less than the third one of the second initial voltages, and the second one of the second initial voltages is less than the third one of the second initial voltages.

In at least one embodiment of the present disclosure, the first one of the second initial voltages is the second initial voltage provided to the first sub-pixel, the second one of the second initial voltages is the second initial voltage provided to the second sub-pixel, and the third one of the second initial voltages is the second initial voltage provided to the third sub-pixel. The first sub-pixel may be a red sub-pixel, the second sub-pixel may be a green sub-pixel, and the third sub-pixel may be a blue sub-pixel.

In a specific implementation, when the driving transistor is a p-type transistor, the data voltage corresponding to the blue sub-pixel is more negative. By setting the third one of the second initial voltages corresponding to the blue sub-pixel to be smaller during the reset of a potential of each second node through each eighth transistor, a gate-source voltage of the red sub-pixel, a gate-source voltage of the green sub-pixel and a gate-source voltage of the blue sub-pixel can be made approximately the same. This provides a nearly same bias state for the driving transistors in each sub-pixel, thereby improving display performance.

When the driving transistor is an n-type transistor, the data voltage corresponding to the blue sub-pixel is more positive. By setting the third one of the second initial voltages corresponding to the blue sub-pixel to be larger during the reset of a potential of each second node through each eighth transistor, the gate-source voltage of the red sub-pixel, the gate-source voltage of the green sub-pixel and the gate-source voltage of the blue sub-pixel can be caused to be approximately the same. This provides a nearly same bias state for the driving transistors in each sub-pixel, thereby improving display performance.

In a specific implementation, when the driving transistor is a p-type transistor, the voltage value of the third one of the second initial voltages may be set to be smaller.

When the driving transistor is a p-type transistor, the voltage value of the third one of the second initial voltages may be set to be larger.

Optionally, the first one of the second initial voltages is equal to the second one of the second initial voltages; or
when the driving transistor is a p-type transistor, the first one of the second initial voltages is less than the second one of the second initial voltages; and when the driving transistor is a n-type transistor, the first one of the second initial voltages is greater than the second one of the second initial voltages.

In a specific implementation, since the pixel current of the red sub-pixel is greater than the pixel current of the green sub-pixel, when the driving transistor is a p-type transistor, the first one of the second initial voltages may be set to be less than the second one of the second initial voltages, and when the driving transistor is a n-type transistor, the first one of the second initial voltages may be set to be greater than the second one of the second initial voltages. This provides a nearly same bias state for the driving transistor in the red sub-pixel and the driving transistor in the green sub-pixel, thereby improving display quality.

In at least one embodiment of the present disclosure, the pixel circuit further includes N third initial voltage terminals, and the n^{th} sub-pixel further includes an n^{th} one of third initialization circuits;
the n^{th} one of the third initialization circuits is electrically connected to each of a third reset control terminal, an n^{th} one of third initial voltage terminals and the first electrode of the n^{th} light emitting element, and is configured to write an n^{th} one of third initial voltages provided by the n^{th} one of the third initial voltage terminals into the first electrode of the n^{th} light emitting element under the control of a third reset control signal provided by the third reset control terminal.

In a specific implementation, the n^{th} sub-pixel may further include an n^{th} one of third initialization circuits. The n^{th} one of the third initialization circuits is configured to write the n^{th} one of the third initial voltages provided by the n^{th} one of the third initial voltage terminals into the first electrode of the n^{th} light emitting element under the control of a third reset control signal, thereby clearing residual charge on the first electrode of the n^{th} light emitting element.

Optionally, third initial voltages provided by the N third initial voltage terminals are the same, but the present disclosure is not limited thereto. In practical operation, the third initial voltages provided by at least two of the third initial voltage terminals may be different from each other.

In practical operation, when the third initial voltages provided by the N third initial voltage terminals are the same, the number of initial voltage lines used to provide the third initial voltage may be reduced.

In at least one embodiment of the present disclosure, the second reset control terminal and the third reset control terminal may be a same control terminal, but the present disclosure is not limited thereto.

In at least one embodiment of the present disclosure, the n^{th} sub-pixel further includes an n^{th} energy storage circuit (ESC), an n^{th} compensation control circuit (CCC) and an n^{th} data writing circuit (DWC);
a first terminal of the n^{th} energy storage circuit is electrically connected to the n^{th} one of the first nodes, a second terminal of the n^{th} energy storage circuit is electrically connected to the direct current voltage terminal, and the n^{th} energy storage circuit is configured to store electrical energy;
the n^{th} compensation control circuit is electrically connected to each of a compensation control terminal, the n^{th} one of the first nodes and the n^{th} one of the third nodes, and is configured to control the n^{th} one of the first nodes to be electrically connected to the n^{th} one of the third nodes under the control of a compensation control signal provided by the compensation control terminal; and
the n^{th} data writing circuit is electrically connected to each of a writing control terminal, an n^{th} data line and the n^{th} one of the second nodes, and is configured to write an n^{th} data voltage provided by the n^{th} data line into the n^{th} one of the second nodes under the control of a writing control signal provided by the writing control terminal.

In a specific implementation, the n^{th} sub-pixel may further include an n^{th} energy storage circuit, an n^{th} compensation control circuit and an n^{th} data writing circuit. The n^{th} energy storage circuit maintains a potential of the n^{th} one of the first nodes. The n^{th} compensation control circuit control the n^{th} one of the first nodes to be electrically connected to the n^{th} one of third nodes under the control of a compensation control signal to perform threshold voltage compensation. The n^{th} data writing circuit writes the n^{th} data voltage provided by the n^{th} data line into the n^{th} one of the second nodes under the control of a writing control signal to perform data voltage writing.

Optionally, the n^{th} sub-pixel further includes an n^{th} one of second light emitting control circuits;
the n^{th} one of the second light emitting control circuits is electrically connected to each of the light emitting control terminal, a first voltage terminal and the n^{th} one of the second nodes, and is configured to control the first voltage terminal to be electrically connected to the n^{th} one of the second nodes under the control of the light emitting control signal.

In a specific implementation, the n^{th} sub-pixel may further include an n^{th} one of second light emitting control circuits. The n^{th} one of the second light emitting control circuits controls the first voltage terminal to be electrically connected to the n^{th} one of the second nodes under the control of a light emitting control signal to perform light emitting control.

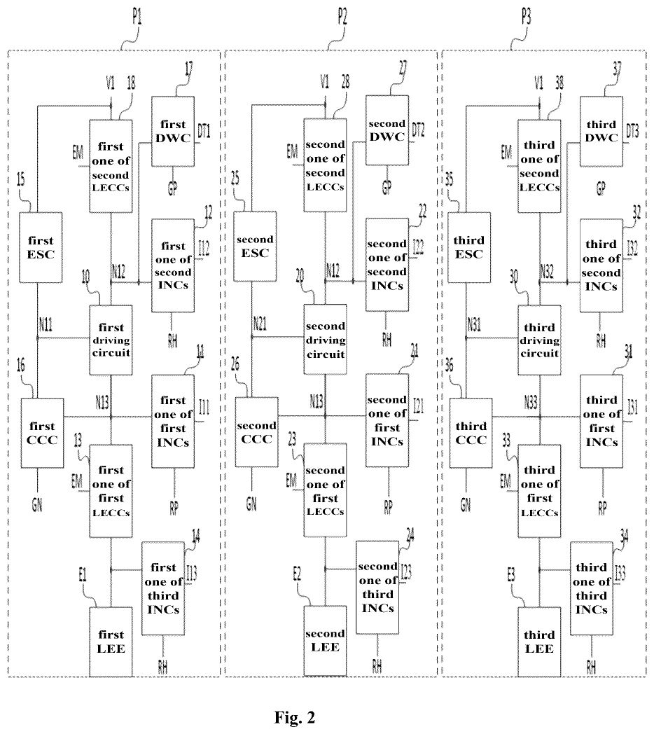

As shown in FIG. 2, on the basis of at least one embodiment of the pixel circuit shown in FIG. 1, the pixel circuit further includes a first one of third initial voltage terminals I13, a second one of third initial voltage terminals I23, and a third one of third initial voltage terminals I33; the first sub-pixel further includes a first one of third initialization circuits 14.

The first one of the third initialization circuits 14 is electrically connected to each of a second reset control terminal RH, a first one of third initial voltage terminals I13 and the first electrode of the first light emitting element E1, and is configured to write a first one of third initial voltages provided by the first one of third initial voltage terminals I13 into the first electrode of the first light emitting element E1 under the control of a second reset control signal provided by the second reset control terminal RH.

The first sub-pixel may further include a first energy storage circuit 15, a first compensation control circuit 16 and a first data writing circuit 17.

A first terminal of the first energy storage circuit 15 is electrically connected to the first one of the first nodes N11, a second terminal of the first energy storage circuit 15 is electrically connected to the first voltage terminal V1, and the first energy storage circuit 15 is configured to store electrical energy.

The first compensation control circuit 16 is electrically connected to each of a compensation control terminal GN, the first one of the first nodes N11 and the first one of third nodes N13, and is configured to control the first one of the first nodes N11 to be electrically connected to the first one of third nodes N13 under the control of a compensation control signal provided by the compensation control terminal GN.

The first data writing circuit 17 is electrically connected to each of a writing control terminal GP, a first data line DT1 and the first one of the second nodes N12, and is configured to write a first data voltage provided by the first data line DT1 into the first one of the second nodes N12 under the control of a writing control signal provided by the writing control terminal GP.

The first sub-pixel further includes a first one of the second light emitting control circuits 18.

The first one of the second light emitting controls circuit 18 is electrically connected to each of the light emitting control terminal EM, a first voltage terminal V1 and the first one of the second nodes N12, and is configured to control the first voltage terminal V1 to be electrically connected to the first one of the second nodes N12 under the control of the light emitting control signal.

The second sub-pixel further includes a second one of third initialization circuits 24.

The second one of the third initialization circuits 24 is electrically connected to each of a second reset control terminal RH, a second one of third initial voltage terminals I23 and the first electrode of the second light emitting element E2, and is configured to write a second one of third initial voltages provided by the second one of the third initial voltage terminals I23 into the first electrode of the second light emitting element E2 under the control of a second reset control signal provided by the second reset control terminal RH.

The second sub-pixel may further include a second energy storage circuit 25, a second compensation control circuit 26 and a first data writing circuit 27.

A first terminal of the second energy storage circuit 25 is electrically connected to the second one of the first nodes N21, a second terminal of the second energy storage circuit 25 is electrically connected to the first voltage terminal V1, and the second energy storage circuit 25 is configured to store electrical energy.

The second compensation control circuit 26 is electrically connected to each of a compensation control terminal GN, the second one of the first nodes N21 and the second one of the third nodes N23, and is configured to control the second one of the first nodes N21 to be electrically connected to the second one of the third nodes N23 under the control of a compensation control signal provided by the compensation control terminal GN.

The second data writing circuit 27 is electrically connected to each of a writing control terminal GP, a second data line DT2 and the second one of the second nodes N22, and is configured to write a second data voltage provided by the second data line DT2 into the second one of the second nodes N22 under the control of a writing control signal provided by the writing control terminal GP.

The second sub-pixel further includes a second one of second light emitting control circuits 28.

The second one of the second light emitting control circuits 28 is electrically connected to each of the light emitting control terminal EM, a first voltage terminal V1 and the second one of the second nodes N22, and is configured to control the first voltage terminal V1 to be electrically connected to the second one of the second nodes N22 under the control of the light emitting control signal.

The third sub-pixel may further include a second energy storage circuit 35, a third compensation control circuit 36 and a third data writing circuit 37.

A first terminal of the third energy storage circuit 35 is electrically connected to the third one of the first nodes N31, a second terminal of the third energy storage circuit 35 is electrically connected to the first voltage terminal V1, and the third energy storage circuit 35 is configured to store electrical energy.

The third compensation control circuit 26 is electrically connected to each of a compensation control terminal GN, the third one of the first nodes N31 and the third one of the third nodes N33, and is configured to control the third one of the first nodes N31 to be electrically connected to the third one of the third nodes N33 under the control of a compensation control signal provided by the compensation control terminal GN.

The third data writing circuit 37 is electrically connected to each of a writing control terminal GP, a third data line DT3 and the third one of the second nodes N32, and is configured to write a third data voltage provided by the third data line DT3 into the third one of the two nodes N32 under the control of a writing control signal provided by the writing control terminal GP.

The third sub-pixel further includes a third one of the second light emitting control circuit 38.

The third one of the second light emitting control circuits 38 is electrically connected to each of the light emitting control terminal EM, a first voltage terminal V1 and the third one of the second nodes N32, and is configured to control the first voltage terminal V1 to be electrically connected to the third one of the second nodes N32 under the control of the light emitting control signal.

Optionally, the first voltage terminal may be a high voltage terminal, and the second voltage terminal may be a low voltage terminal.

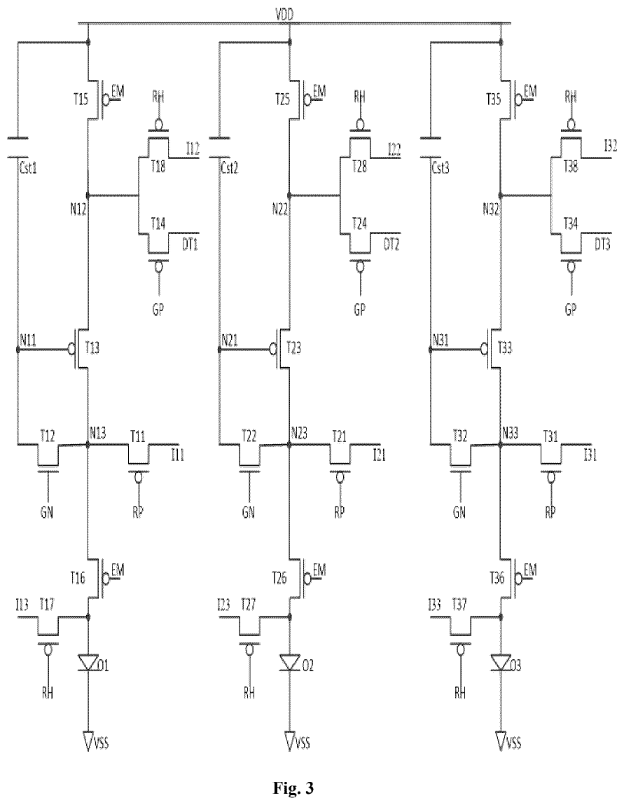

As shown in FIG. 3, in at least one embodiment of the pixel circuit shown in FIG. 2, the first driving circuit 10 may include a first driving transistor T13, and the first light emitting element is a first organic light emitting diode O1. The first one of first initialization circuits includes a first one of first initialization transistors T11, the first one of the second initialization circuits includes a first one of second initialization transistors T18, and the first one of the first light emitting control circuits includes a first on of first light emitting control transistors T16.

A gate electrode of the first driving transistor T13 is electrically connected to the first one of the first nodes N11, a source electrode of the first driving transistor T13 is electrically connected to the first one of the second nodes N12, and a drain electrode of the first driving transistor T13 is electrically connected to the first one of the third nodes N13.

A gate electrode of the first one of the first light emitting control transistors T16 is electrically connected to the light emitting control terminal EM, a source electrode of the first one of the first light emitting control transistors T16 is electrically connected to the first one of the third nodes N13, a drain electrode of the first one of the first light emitting control transistors T16 is electrically connected to an anode of the first organic light emitting diode O1, and a cathode of the O1 is electrically connected to a low voltage terminal VSS.

A gate electrode of the first one of the first initialization transistors T11 is electrically connected to a first reset control terminal RP, a source electrode of the first one of the first initialization transistors T11 is electrically connected to the first one of the first initial voltage terminals I11, and a drain electrode of the first one of the first initialization transistors T11 is electrically connected to the first one of the third nodes N13.

A gate electrode of the first one of the second initialization transistors T18 is electrically connected to the second reset control terminal RH, a source electrode of the first one of the second initialization transistors T18 is electrically connected to the first one of the second initial voltage terminals I12, and a drain electrode of the first one of the second initialization transistors T18 is electrically connected to the first one of the second nodes N12.

The first one of the third initializations circuit 14 includes a first one of third initialization transistors T17.

A gate electrode of the first one of the third initialization transistors T17 is electrically connected to the second reset control terminal RH, a source electrode of the first one of the third initialization transistors T17 is electrically connected to the first one of the third initial voltage terminals I13, and a drain electrode of the first one of the third initialization transistors T17 is electrically connected to an anode of the first organic light emitting diode O1.

The first energy storage circuit includes a first storage capacitor Cst1, the first compensation control circuit includes a first compensation control transistor T12, and the first data writing circuit includes a first data writing transistor T14.

A first terminal of the first storage capacitor Cst1 is electrically connected to the first one of the first nodes N11, and a second terminal of the first storage capacitor Cst1 is electrically connected to the high voltage terminal VDD.

A gate electrode of the first compensation control transistor T12 is electrically connected to the compensation control terminal GN, a source electrode of the first compensation control transistor T12 is electrically connected to the first one of the first nodes N11, and a drain electrode of the first compensation control transistor T12 is electrically connected to the first one of the third nodes N13.

A gate electrode of the first data writing transistor T14 is electrically connected to the writing control terminal GP, a source electrode of the first data writing transistor T14 is electrically connected to the first data line DT1, and a drain electrode of the first data writing transistor T14 is electrically connected to the first one of the second nodes N12.

The first one of the second light emitting control circuits includes a first one of second light emitting control transistors T15.

A gate electrode of the first one of the second light emitting control transistors T15 is electrically connected to the light emitting control terminal EM, a source electrode of the first one of the second light emitting control transistors T15 is electrically connected to the high voltage terminal VDD, and a drain electrode of the first one of the second light emitting control transistors T15 is electrically connected to the first one of the second nodes N12.

The second driving circuit may include a second driving transistor T2, and the second light emitting element is a second organic light emitting diode O2. The second one of the first initialization circuits includes a second one of first initialization transistors T21, the second one of the second initialization circuits includes a second one of second initialization transistors T28, and the second one of the first light emitting control circuits includes a second one of first light emitting control transistors T26.

A gate electrode of the second driving transistor T23 is electrically connected to the second one of the first node N21, a source electrode of the second driving transistor T23 is electrically connected to the second one of the second nodes N22, and a drain electrode of the second driving transistor T23 is electrically connected to the second one of the third nodes N23.

A gate electrode of the second one of the first light emitting control transistors T26 is electrically connected to the light emitting control terminal EM, a source electrode of the second one of the first light emitting control transistors T26 is electrically connected to the second one of the third nodes N23, and a drain electrode of the second one of the first light emitting control transistors T26 is electrically connected to an anode of the second organic light emitting diode O2.

A gate electrode of the second one of the first initialization transistors T21 is electrically connected to the first reset control terminal RP, a source electrode of the second one of the first initialization transistor T21 is electrically connected to the second one of the first initial voltage terminals I21, and a drain electrode of the second one of the first initialization transistors T21 is electrically connected to the second one of the third nodes N23.

A gate electrode of the second one of the second initialization transistors T28 is electrically connected to the second reset control terminal RH, a source electrode of the second one of the second initialization transistors T28 is electrically connected to the second one of the second initial voltage terminals I22, and a drain electrode of the second one of the second initialization transistors T28 is electrically connected to the second one of the second nodes N22.

The second one of the third initialization circuits includes a second one of third initialization transistors T27.

A gate electrode of the second one of third initialization transistors T27 is electrically connected to the second reset control terminal RH, a source electrode of the second one of the third initialization transistors T27 is electrically connected to the second one of the third initial voltage terminals I23, a drain electrode of the second one of the third initialization transistors T27 is electrically connected to an anode of the second organic light emitting diode O2, and a cathode of the O2 is electrically connected to a low voltage terminal VSS.

The second energy storage circuit includes a second storage capacitor Cst2, the second compensation control circuit includes a second compensation control transistor T22, and the second data writing circuit includes a second data writing transistor T24.

A first terminal of the second storage capacitor Cst2 is electrically connected to the second one of the first nodes N21, and a second terminal of the second storage capacitor Cst2 is electrically connected to the high voltage terminal VDD.

A gate electrode of the second compensation control transistor T22 is electrically connected to the compensation control terminal GN, a source electrode of the second compensation control transistor T22 is electrically connected to the second one of the first nodes N21, and a drain electrode of the second compensation control transistor T22 is electrically connected to the second one of the third nodes N23.

A gate electrode of the second data writing transistor T24 is electrically connected to the writing control terminal GP, a source electrode of the second data writing transistor T24 is electrically connected to the second data line DT2, and a drain electrode of the second data writing transistor T24 is electrically connected to the second one of the second nodes N22.

The second one of the second light emitting control circuits includes a second one of the second light emitting control transistors T25.

A gate electrode of the second one of the second light emitting control transistors T25 is electrically connected to the light emitting control terminal EM, a source electrode of the second one of the second light emitting control transistors T25 is electrically connected to the high voltage terminal VDD, and a drain electrode of the second one of the second light emitting control transistors T25 is electrically connected to the second one of the second nodes N22.

The third driving circuit may include a third driving transistor T3, and the third light emitting element is a third organic light emitting diode O3. The third one of the first initialization circuits includes a third one of first initialization transistors T31, the third one of the second initialization circuits includes a third one of second initialization transistors T38, and the third one of the first light emitting control circuits includes a third one of first light emitting control transistors T36.

A gate electrode of the third driving transistor T33 is electrically connected to the third one of the first nodes N31, a source electrode of the third driving transistor T33 is electrically connected to the third one of the second nodes N32, and a drain electrode of the third driving transistor T33 is electrically connected to the third one of the third nodes N33.

A gate electrode of the third one of the first light emitting control transistors T36 is electrically connected to the light emitting control terminal EM, a source electrode of the third one of the first light emitting control transistors T36 is electrically connected to the third one of the third nodes N33, and a drain electrode of the third one of the first light emitting control transistors T36 is electrically connected to an anode of the third organic light emitting diode O3.

A gate electrode of the third one of the first initialization transistors T31 is electrically connected to the first reset control terminal RP, a source electrode of the third one of the first initialization transistors T31 is electrically connected to the third one of the first initial voltage terminals I31, and a drain electrode of the third one of the first initialization transistors T31 is electrically connected to the third one of the third nodes N33.

A gate electrode of the third one of the second initialization transistors T38 is electrically connected to the second reset control terminal RH, a source electrode of the third one of the second initialization transistors T38 is electrically connected to the third one of the second initial voltage terminals I32, and a drain electrode of the third one of the second initialization transistors T38 is electrically connected to the third one of the second node N32.

The third one of the third initialization circuits includes a third one of third initialization transistors T37.

A gate electrode of the third one of the third initialization transistors T37 is electrically connected to the second reset control terminal RH, a source electrode of the third one of the third initialization transistors T37 is electrically connected to the third one of the third initial voltage terminals I33, a drain electrode of the third one of the third initialization transistors T37 is electrically connected to an anode of the third organic light emitting diode O3, and a cathode of the O3 is electrically connected to the low voltage terminal VSS.

The third energy storage circuit includes a third storage capacitor Cst3, the third compensation control circuit includes a third compensation control transistor T32, and the third data writing circuit includes a third data writing transistor T34.

A first terminal of the third storage capacitor Cst3 is electrically connected to the third one of the first nodes N31, and a second terminal of the third storage capacitor Cst3 is electrically connected to the high voltage terminal VDD.

A gate electrode of the third compensation control transistor T32 is electrically connected to the compensation control terminal GN, a source electrode of the third compensation control transistor T32 is electrically connected to a third one of first nodes N31, and a drain electrode of the third compensation control transistor T32 is electrically connected to a third one of third nodes N33.

A gate electrode of the third data writing transistor T34 is electrically connected to the writing control terminal GP, a source electrode of the third data writing transistor T34 is electrically connected to a third data line DT3, and a drain electrode of the third data writing transistor T34 is electrically connected to the third one of the second nodes N32.

The third one of the second light emitting control circuits includes a third one of second light emitting control transistors T35.

A gate electrode of the third one of second light emitting control transistors T35 is electrically connected to the light emitting control terminal EM, a source electrode of the third one of the second light emitting control transistors T35 is electrically connected to the high voltage terminal VDD, and a drain electrode of the third one of the second light emitting control transistors T35 is electrically connected to the third one of the second nodes N32.

In at least one embodiment of the pixel circuit shown in FIG. 3, the T12, the T22 and the T32 are n-type transistors, and other transistors are p-type transistors, but the present disclosure is not limited thereto.

In at least one embodiment, when the pixel circuit shown in FIG. 3 of the present disclosure is in operation, a display period may include a first reset phase, a second reset phase, a data writing phase, a third reset phase, and a light emitting phase arranged sequentially in that order.

In the first reset phase, the RH provides a low voltage signal, the T18, the T28, the T38, the T17, the T27, and the T37 are turned on, the I12 provides a first one of second initial voltages to the N12, the I22 provides a second one of second initial voltages to the N22, the I32 provides a third one of the second initial voltages to the N32; the I13 provides a first one of third initial voltages to the anode of the O1, the I23 provides a second one of third initial voltages to the anode of the O2, and the I33 provides a third one of third initial voltages to the anode of the O3, to clear residual charges on the anodes of the O1, the O2, and the O3.

In the second reset phase, the RH provides a high voltage signal, the RP provides a low voltage signal, the GN provides a high voltage signal, the T11 and the T12 are turned on, the I11 provides a first one of first initial voltages to the N11, so that the T13 can be turned on at the beginning of the data writing phase; the T21 and the T22 are turned on, and the I21 provides a second one of first initial voltages to the N21, so that the T23 can be turned on at the beginning of the data writing phase; the T31 and the T32 are turned on, and the I31 provides a third one of first initial voltages to the N31, so that the T33 can be turned on at the beginning of the data writing phase.

In the data writing phase, the GN provides a high voltage signal, the GP provides a low voltage signal, the RH provides a low voltage signal, the RP provides a high voltage signal, and the T14 and the T12 are turned on; the DT1 writes the first data voltage Vdata1 into the N12, the DT2 writes the second data voltage Vdata2 into the N22, and the DT3 writes the third data voltage Vdata3 into the N32.

At the beginning of the data writing phase, the T13, the T23, and the T33 are turned on, Vdata1 charges the Cst1 to change a potential of the N11 until the potential of N11 becomes Vdata1+Vth1 and the T13 is turned off; Vdata2 charges the Cst2 to change a potential of the N21 until the potential of the N21 becomes Vdata2+Vth2 and the T23 is turned off; Vdata3 charges the Cst3 to change a potential of the N31 until the potential of the N31 becomes Vdata3+Vth3 and the T33 is turned off; Vth1 is the threshold voltage of the T13, Vth2 is the threshold voltage of the T23, and Vth3 is the threshold voltage of the T33;

In the third reset phase, the RH provides a low voltage signal, the T17 and the T18 are turned on, the I13 provides a first one of third initial voltages to the anode of the O1 to clear the residual charge of the anode of the O1, and the I12 provides a first one of second initial voltages to the N12 to improve the hysteresis; the I23 provides a second one of third initial voltages to the anode of the O2 to clear the residual charge of the anode of the O2, and the I22 provides a second one of second initial voltages to the N22 to improve the hysteresis; the I33 provides a third one of third initial voltages to the anode of the O3 to clear the residual charge of the anode of the O3, and the I32 provides a third one of second initial voltages to the N13 to improve the hysteresis.

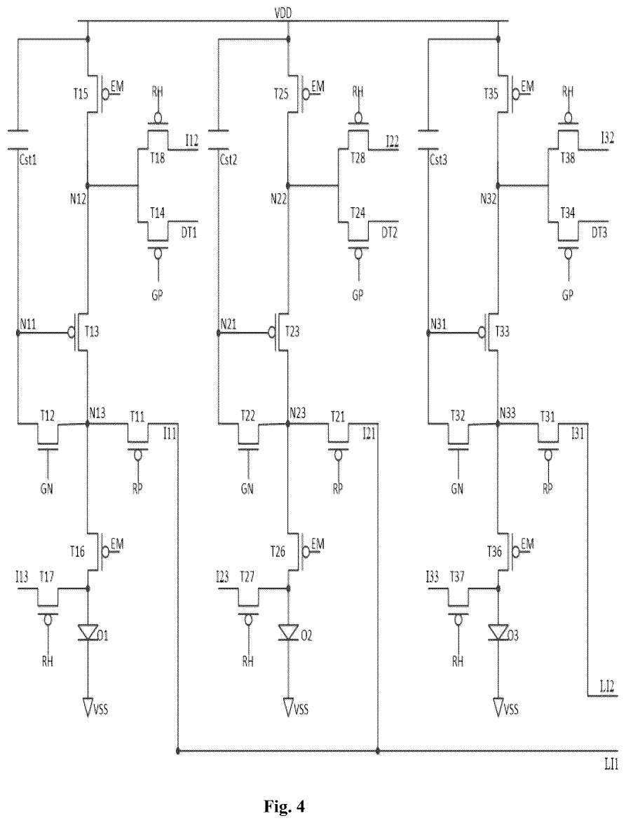

As shown in FIG. 4, on the basis of at least one embodiment of the pixel circuit shown in FIG. 3, both the I11 and the I21 are electrically connected to a first initial voltage line LI1 to receive an initial voltage from the first initial voltage line LI1.

The I31 is electrically connected to a second initial voltage line LI2 to receive an initial voltage from the second initial voltage line LI2.

In at least one embodiment shown in FIG. 4, the first one of the first initial voltages is greater than the third one of the first initial voltage, the second one of the first initial voltages is greater than the third one of the first initial voltages, and the first one of the first initial voltages is equal to the second one of the first initial voltages.

In at least one embodiment shown in FIG. 4, the first one of the second initial voltages provided by the I12, the second one of the second initial voltages provided by the I22, and the third one of the second initial voltages provided by the I32 may be equal.

The first one of the third initial voltages provided by the I13, the second one of third initial voltages provided by the I23, and the third one of the third initial voltages provided by the I33 may be equal; but the present disclosure is not limited to this.

In at least one embodiment of the present disclosure, an added initial voltage wire may overlap with other circuit wires, which does not cause an additional layout space problem.

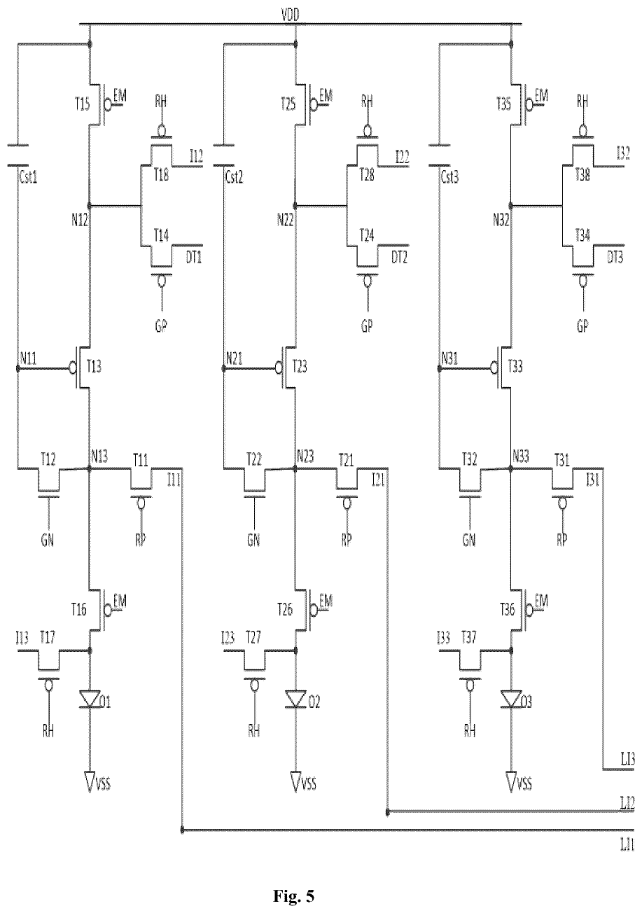

As shown in FIG. 5, on the basis of at least one embodiment of the pixel circuit shown in FIG. 3, the I11 is electrically connected to the first initial voltage line LI1, the I21 is electrically connected to the second initial voltage line LI2, and the I31 is electrically connected to a third initial voltage line LI3.

The I11 receives the initial voltage from the first initial voltage line LI1, the I21 receives the initial voltage from the second initial voltage line LI2, and the I31 receives the initial voltage from the third initial voltage line LI3.

In at least one embodiment shown in FIG. 5, the first one of the first initial voltages is greater than the third one of the first initial voltages, the second one of the first initial voltages is greater than the third one of the first initial voltages, and the first one of the first initial voltages is less than the second one of the first initial voltages.

In at least one embodiment of the pixel circuit shown in FIG. 5, the first initial voltages accessed by each first initialization transistor in the first sub-pixel, the second sub-pixel, and the third sub-pixel are different, and during a high frequency display, different pixel node voltages may be reset in a targeted manner, and a same bias state is provided for the driving transistor. By controlling multiple first initial voltage terminals, the image display with higher precision can be achieved at a high frequency.

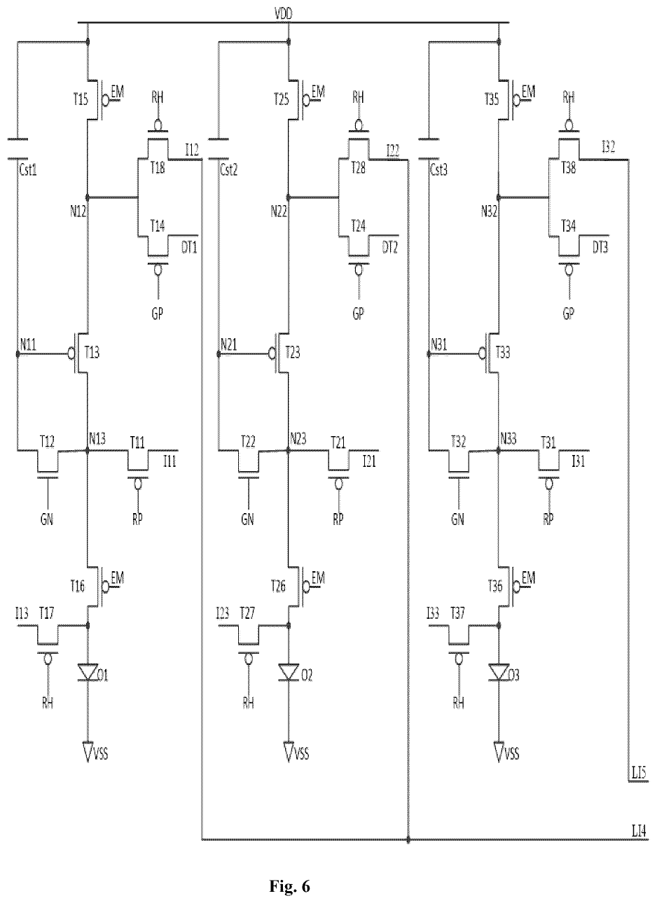

As shown in FIG. 6, on the basis of at least one embodiment of the pixel circuit shown in FIG. 3, the I12 is electrically connected to a fourth initial voltage line LI4, the I22 is electrically connected to the fourth initial voltage line LI4, and the I32 is electrically connected to a fifth initial voltage line LI5.

The I12 and the I22 receive the initial voltage from the fourth initial voltage line LI4, and the I32 receives the initial voltage from the fifth initial voltage line LI5.

In at least one embodiment shown in FIG. 6, the first one of the second initial voltages is equal to the second one of the second initial voltages, and the first one of the second initial voltages is greater than the third one of the second initial voltages.

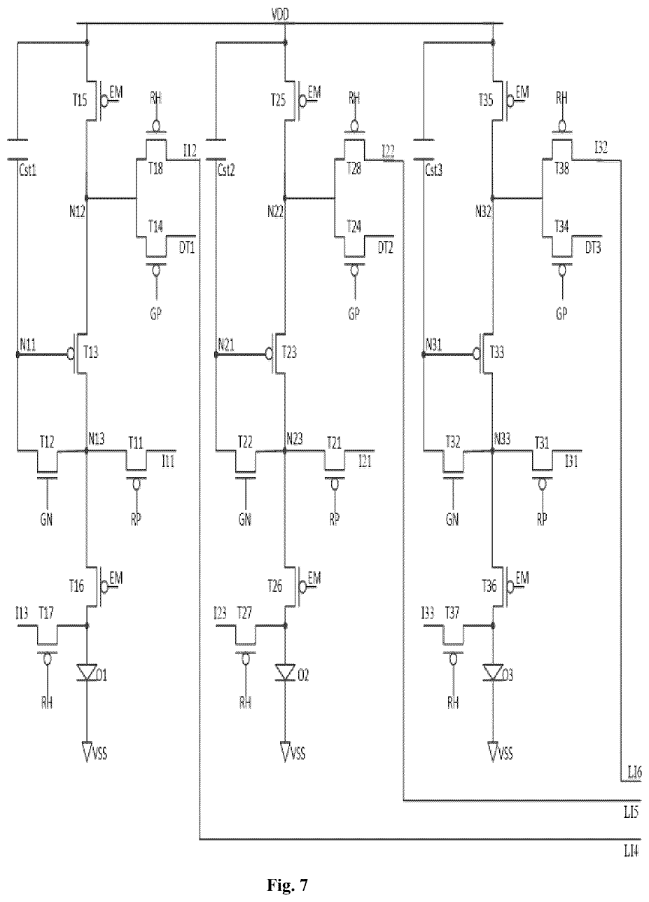

As shown in FIG. 7, on the basis of at least one embodiment of the pixel circuit shown in FIG. 3, the I12 is electrically connected to the fourth initial voltage line LI4, the I22 is electrically connected to the fifth initial voltage line LI5, and the I32 is electrically connected to a sixth initial voltage line LI6.

The I12 receives the initial voltage from the fourth initial voltage line LI4, the I22 receives the initial voltage from the fifth initial voltage line LI5, and the I32 receives the initial voltage from the sixth initial voltage line LI6.

In at least one embodiment shown in FIG. 7, the first one of the second initial voltages is less than the second one of the second initial voltages, and the first one of the second initial voltages is greater than the third one of the second initial voltage.

In at least one embodiment of the pixel circuit shown in FIG. 7, the second initial voltages accessed by each second initialization transistor in the first sub-pixel, the second sub-pixel, and the third sub-pixel are different, and during a high frequency display, different pixel node voltages may be reset in a targeted manner, and a same bias state is provided for the driving transistor. By controlling multiple second initial voltage terminals, the image display with higher precision can be achieved at a high frequency.

The driving method according to the embodiments of the present disclosure is applied to the above-mentioned pixel circuit, and the driving method includes:
generating, by the n^{th} driving circuit, the driving current for driving the n^{th} light emitting element under the control of a potential of the n^{th} one of the first nodes;
controlling, by the n^{th} first light emitting control circuit, the n^{th} one of the third nodes to be electrically connected to the first electrode of the n^{th} light emitting element under the control of the light emitting control signal;
writing, by the n^{th} one of the first initialization circuits, the n^{th} one of the first initial voltages provided by the n^{th} one of the first initial voltage terminal into the n^{th} one of the third nodes under the control of the first reset control signal;
writing, by the n^{th} one of the second initialization circuits, the n^{th} one of the second initial voltages provided by the n^{th} one of the second initial voltage terminals into the n^{th} one of the second nodes under the control of the second reset control signal;
the first initial voltages provided by at least two of the first initial voltage terminals are different from each other, and/or the second initial voltages provided by at least two of the second initial voltage terminals are different from each other;
where N is an integer greater than 1 and n is a positive integer less than or equal to N.

According to embodiments of the present disclosure, a display device includes the above-mentioned pixel circuit.

The above are preferred embodiments of the present disclosure. It should be noted that for those of ordinary skill in the art, improvements and modifications can be made without departing from the principle of the present disclosure, and these improvements and modifications shall also fall within the scope of the present disclosure.

1. A pixel circuit, comprising N sub-pixels, N first initial voltage terminals and N second initial voltage terminals, wherein N is an integer greater than 1 and n is a positive integer less than or equal to N;
an n^{th} sub-pixel comprises an n^{th} driving circuit, an n^{th} light emitting element, an n^{th} one of first initialization circuits, an n^{th} one of second initialization circuits and an n^{th} one of first light emitting control circuits;
a control terminal of the n^{th} driving circuit is electrically connected to an n^{th} one of first nodes, a first terminal of the n^{th} driving circuit is electrically connected to an n^{th} one of second nodes, a second terminal of the n^{th} driving circuit is electrically connected to an n^{th} one of third nodes, and the n^{th} driving circuit is configured to generate a driving current for driving the n^{th} light emitting element under the control of a potential of the n^{th} one of the first nodes;
the n^{th} one of the first light emitting control circuits is electrically connected to each of a light emitting control terminal, the n^{th} one of the third nodes and a first electrode of the n^{th} light emitting element, and is configured to control the n^{th} one of the third nodes to be electrically connected to the first electrode of the n^{th} light emitting element under the control of a light emitting control signal provided by the light emitting control terminal, and a second electrode of the n^{th} light emitting element is electrically connected to a second voltage terminal;
the n^{th} one of the first initialization circuits is electrically connected to each of a first reset control terminal, an n^{th} one of the first initial voltage terminals and the n^{th} one of the third nodes, and is configured to write an n^{th} one of first initial voltages provided by the n^{th} one of the first initial voltage terminals into the n^{th} one of the third nodes under the control of a first reset control signal provided by the first reset control terminal;
the n^{th} one of the second initialization circuits is electrically connected to each of a second reset control terminal, an n^{th} one of the second initial voltage terminals and the n^{th} one of the second nodes, and is configured to write an n^{th} one of second initial voltages provided by the n^{th} one of the second initial voltage terminals into the n^{th} one of the second nodes under the control of a second reset control signal provided by the second reset control terminal;
first initial voltages provided by at least two of the first initial voltage terminals are different from each other, and/or the second initial voltages provided by at least two of the second initial voltage terminals are different from each other.

2. The pixel circuit according to claim 1, wherein the pixel circuit comprises three sub-pixels, wherein a first one of the sub-pixels is a red sub-pixel, a second one of the sub-pixels is a green sub-pixel, and a third one of the sub-pixels is a blue sub-pixel;
a first one of the first initial voltages is different from a third one of the first initial voltages, and a second one of the first initial voltages is different from the third one of the first initial voltages.

3. The pixel circuit according to claim 2, wherein a driving transistor comprised in each driving circuit is a p-type transistor, the first one of the first initial voltages is greater than the third one of the first initial voltages, and the second one of the first initial voltages is greater than the third one of the first initial voltages; or
a driving transistor comprised in each driving circuit is an n-type transistor, the first one of the first initial voltages is less than the third one of the first initial voltages, and the second one of the first initial voltages is less than the third one of the first initial voltages.

4. The pixel circuit according to claim 3, wherein the first one of the first initial voltages is equal to the second one of the first initial voltages.

5. The pixel circuit according to claim 3, wherein the driving transistor is the p-type transistor, and the first one of the first initial voltages is less than the second one of the first initial voltages; or
the driving transistor is the n-type transistor, and the first one of the first initial voltages is greater than the second one of the first initial voltages.

6. The pixel circuit according to claim 1, wherein the pixel circuit comprises three sub-pixels, a first one of the sub-pixels is a red sub-pixel, a second one of the sub-pixels is a green sub-pixel, and a third one of the sub-pixels is a blue sub-pixel;
a first one of the second initial voltages is different from a third one of the second initial voltages, and a second one of the second initial voltages is different from the third one of the second initial voltages.

7. The pixel circuit according to claim 6, wherein a driving transistor comprised in each driving circuit is a p-type transistor, the first one of the second initial voltages is greater than the third one of the second initial voltages, and the second one of the second initial voltages is greater than the third one of the second initial voltages; or
a driving transistor comprised in each driving circuit is an n-type transistor, the first one of the second initial voltages is less than the third one of the second initial voltages, and the second one of the second initial voltages is less than the third one of the second initial voltages.

8. The pixel circuit according to claim 7, wherein the first one of the second initial voltages is equal to the second one of the second initial voltages.

9. The pixel circuit according to claim 7, wherein the driving transistor is the p-type transistor, and the first one of the second initial voltages is less than the second one of the second initial voltages; or
the driving transistor is the n-type transistor, and the first one of the second initial voltages is greater than the second one of the second initial voltages.

10. The pixel circuit according to claim 1, wherein the pixel circuit further comprises N third initial voltage terminals, and the n^{th} sub-pixel further comprises an n^{th} one of third initialization circuits;
the n^{th} one of the third initialization circuits is electrically connected to each of a third reset control terminal, an n^{th} one of the third initial voltage terminals and the first electrode of the n^{th} light emitting element, and is configured to write an n^{th} one of third initial voltages provided by the n^{th} one of the third initial voltage terminals into the first electrode of the n^{th} light emitting element under the control of a third reset control signal provided by the third reset control terminal.

11. The pixel circuit according to claim 10, wherein the respective third initial voltages provided by the N third initial voltage terminals are the same.

12. The pixel circuit according to claim 1, wherein the n^{th} sub-pixel further comprises an n^{th} energy storage circuit, an n^{th} compensation control circuit and an n^{th} data writing circuit;
a first terminal of the n^{th} energy storage circuit is electrically connected to the n^{th} one of the first nodes, a second terminal of the n^{th} energy storage circuit is electrically connected to a direct current voltage terminal, and the n^{th} energy storage circuit is configured to store electrical energy;
the n^{th} compensation control circuit is electrically connected to each of a compensation control terminal, the n^{th} one of the first nodes and the n^{th} one of the third nodes, and is configured to control the n^{th} one of the first nodes to be electrically connected to the n^{th} one of the third nodes under the control of a compensation control signal provided by the compensation control terminal; and
the n^{th} data writing circuit is electrically connected to each of a writing control terminal, an n^{th} data line and the n^{th} one of the second nodes, and is configured to write an n^{th} data voltage provided by the n^{th} data line into the n^{th} one of the second nodes under the control of a writing control signal provided by the writing control terminal.

13. The pixel circuit according to claim 1, wherein the n^{th} sub-pixel further comprises an n^{th} one of second light emitting control circuits;
the n^{th} one of the second light emitting control circuits is electrically connected to each of the light emitting control terminal, a first voltage terminal and the n^{th} one of the second nodes, and is configured to control the first voltage terminal to be electrically connected to the n^{th} one of the second nodes under the control of the light emitting control signal.

14. A driving method, applied to the pixel circuit according to claim 1, wherein the driving method comprises:
generating, by the n^{th} driving circuit, the driving current for driving the n^{th} light emitting element under the control of a potential of the n^{th} one of the first nodes;
controlling, by the n^{th} one of the first light emitting control circuits, the n^{th} one of the third nodes to be electrically connected to the first electrode of the n^{th} light emitting element under the control of the light emitting control signal;
writing, by the n^{th} one of the first initialization circuits, the n^{th} one of the first initial voltages provided by the n^{th} one of the first initial voltage terminals into the n^{th} one of the third nodes under the control of the first reset control signal;
writing, by the n^{th} one of the second initialization circuits, the n^{th} one of the second initial voltages provided by the n^{th} one of the second initial voltage terminals into the n^{th} one of the second nodes under the control of the second reset control signal;
the first initial voltages provided by the at least two of the first initial voltage terminals are different from each other, and/or the second initial voltages provided by the at least two of the second initial voltage terminals are different from each other;
wherein N is an integer greater than 1, and n is a positive integer less than or equal to N.

15. A display device comprising the pixel circuit according to claim 1.

16. The display device according to claim 15, wherein the pixel circuit comprises three sub-pixels, wherein a first one of the sub-pixels is a red sub-pixel, a second one of the sub-pixels is a green sub-pixel, and a third one of the sub-pixels is a blue sub-pixel;
a first one of the first initial voltages is different from a third one of the first initial voltages, and a second one of the first initial voltages is different from the third one of the first initial voltages.

17. The display device according to claim 16, wherein a driving transistor comprised in each driving circuit is a p-type transistor, the first one of the first initial voltages is greater than the third one of the first initial voltages, and the second one of the first initial voltages is greater than the third one of the first initial voltages; or
a driving transistor comprised in each driving circuit is an n-type transistor, the first one of the first initial voltages is less than the third one of the first initial voltages, and the second one of the first initial voltages is less than the third one of the first initial voltages.

18. The display device according to claim 17, wherein the first one of the first initial voltages is equal to the second one of the first initial voltages.

19. The display device according to claim 17, wherein the driving transistor is the p-type transistor, and the first one of the first initial voltages is less than the second one of the first initial voltages; or
the driving transistor is the n-type transistor, and the first one of the first initial voltages is greater than the second one of the first initial voltages.

20. The display device according to claim 15, wherein the pixel circuit comprises three sub-pixels, a first one of the sub-pixels is a red sub-pixel, a second one of the sub-pixels is a green sub-pixel, and a third one of the sub-pixels is a blue sub-pixel;
a first one of the second initial voltages is different from a third one of the second initial voltages, and a second one of the second initial voltages is different from the third one of the second initial voltages.
